(19) United States
(12) Patent Application Publication
(10) Pub. No.: US 2018/0176416 A1
(43) Pub. Date: Jun. 21, 2018

(54) AUTHENTICATED PROCESSING OF DOCUMENTS

(71) Applicant: Gobbill Pty Ltd, Preston (AU)

(72) Inventors: Shendon Ewans, Melbourne (AU); Quentin Marsh, Melbourne (AU)

(21) Appl. No.: 15/802,554

(22) Filed: Nov. 3, 2017

(30) Foreign Application Priority Data
Dec. 21, 2016 (AU) 2016905299
Dec. 21, 2016 (AU) 2016905300
Sep. 21, 2017 (AU) 2017232155

(51) Int. Cl. H04N 1/44; H04L 12/58; G06Q 10/10; G06F 17/30; H04N 1/00

(52) U.S. Cl. CPC H04N 1/4406; H04L 51/22; H04N 1/00225; G06F 17/30011; G06Q 10/107

(57) ABSTRACT

The present invention relates broadly to a method of electronically processing a document via an electronic document processing system. The document processing system is deployed to users via a responsive website accessed via the internet and a web browser on the user's computer or more typically mobile device. The system includes modules for validating the email source of a document and converting the document in its native format to a structured file format. The system also includes modules for authenticating data extracted from predetermined fields in the structured format file by application of predetermined authenticity rules. In the event the document is successfully authenticated, the electronic processing system prompts for payment of the document via secure payment gateways.

### TECHNICAL FIELD

The present invention relates broadly to a method of electronically processing a document via an electronic document processing system. The invention also relates broadly to a method of validating an email source from which a document is received via an electronic document processing system.

### BACKGROUND

As postage costs rises and delivery frequency declines, more organisations are sending documents such as bills to consumers via email. The same trend is occurring worldwide with the decline of traditional postage. There is an absence of convenient mobile digital options for individuals to manage a growing volume of electronic documents such as bills via email. It is generally assumed that an emailed document is genuine, failing to recognize that some such emailed documents may be fake. Online behaviours have changed, while options for presentment of data received by email and responsive processing of same have not. These factors combine to make it difficult to receive documents such as bills by email and safely process them.

### SUMMARY

According to a first aspect of the present invention there is provided a method of electronically processing a document via an electronic document processing system, said method comprising the steps of:

allocating a plurality of recipient email addresses to respective of a plurality of users of the document processing system;

for each of the plurality of users, associating the recipient email address with a user email address nominated by the user;

for each of the plurality of users, associating one or more identities associated with a source of a document with the recipient email address, each of said one or more identities being associated with respective of one or more email servers;

receiving a document from an email source having an email source address, said document being received at a designated email address at a recipient email server associated with the plurality of recipient email addresses;

validating the email source from which the document is received at the recipient email server, said validation involving the steps of i) verifying the designated email address by matching it with one of the plurality of allocated recipient email addresses, and ii) reconciling the email source address with either the user email address associated with the matched recipient email address, or one of the email servers associated with the matched recipient email address;

provided the email source is successfully validated, processing the document by converting it to a structured format file;

extracting data from predetermined data fields in the structured format file;

authenticating the document by applying predetermined authenticity rules to the extracted data.

Preferably the method of processing the document comprises the step of, prior to processing the document by converting it to a structured format file, scanning email text associated with the document to identify an identity associated with a source of a document and confirming the identity is one of said one or more identities associated with the system. More preferably the step of scanning the email text comprises applying an identity extraction engine configured to extract the name of the identity based on predetermined keywords and/or character string patterns.

Preferably the step of converting the document to a structured format file comprises the steps of:

providing a plurality of extraction engines each configured to extract data of a characteristic suited to that extraction engine;

selecting one or more of the plurality of extraction engines to be applied to the document depending on the native format of the document;

applying the selected extraction engines to the native document wherein the output file is constructed from the extracted data of the suited characteristic of the respective extraction engine.

According to a second aspect of the invention there is provided a method of validating an email source via an electronic document processing system, said method comprising the steps of:

allocating a plurality of recipient email addresses to respective of a plurality of users of the document processing system;

for each of the plurality of users, associating the recipient email address with a user email address nominated by the user;

for each of the plurality of users, associating one or more identities associated with a source of a document with the recipient email address, each of said one or more identities being associated with respective of one or more email servers;

receiving a document from an email source having an email source address, said document being received at a designated email address at a recipient email server associated with the plurality of recipient email addresses;

validating the email source from which the document is received at the recipient email server, said validation involving the steps of i) verifying the designated email address by matching it with one of the plurality of allocated recipient email addresses, and ii) reconciling the email source address with either the user email address associated with the matched recipient email address, or one of the email servers associated with the matched recipient email address.

Preferably the step of validating the email source from which the document is received at the recipient email server comprises the step of analysing routing information in an email header associated with the document and confirming the routing information is consistent with stored historical routing information associated with the matched recipient email address.

Preferably the method of validating the email source comprises the step of processing the document by i) converting the document from its native format to an output file in a structured format file, ii) extracting data from predetermined data fields in the structured format file, iii) authenticating the document by applying a set of predetermined authenticity rules to the extracted data. More preferably the step of converting the document to a structured format file comprises the steps of:

providing a plurality of extraction engines each configured to extract data of a characteristic suited to that extraction engine;

selecting one or more of the plurality of extraction engines to be applied to the document depending on the native format of the document;

applying the selected extraction engines to the native document wherein the output file is constructed from the extracted data of the suited characteristic of the respective extraction engine.

According to a third aspect of the invention there is provided a method of electronically processing a document, said method comprising the steps of:

receiving the document in a native format;

providing a plurality of extraction engines each configured to extract data of a characteristic suited to that extraction engine;

selecting one or more of the plurality of extraction engines to be applied to the document depending on the native format of the document;

converting the document from its native format to an output file in a structured format by applying the selected extraction engines to the native document wherein the output file is constructed from the extracted data of the suited characteristic of the respective extraction engine;

providing the output file in the structured format.

Preferably the method of electronically processing the document comprises the step of authenticating the document by applying predetermined authenticity rules to the extracted data.

Preferably the application of the selected extraction engines comprises sequentially applying multiple optical character recognition engines to the document. More preferably the application of the selected extraction engines comprises applying one or more predictive extraction engines including deep learning algorithms configured for targeted extraction of data from the document, said data extracted via the predictive extraction engines combining with extracted data from other of the selected extraction engines. Still more preferably the step of sequentially applying the selected extraction engines comprises comparing extracted data from the preceding engine and, depending on differences in results, combining the extracted data from each of the selected extraction engines to obtain the output structured format file at a relatively high accuracy.

Preferably the step of authenticating the document comprises comparing extracted data relating to payment of the document with payment data of verified or fraudulent sources, and applying payment rules of the predetermined authenticity rules to the compared extracted payment data to approve the document for payment. More preferably the step of authenticating the document comprises applying fraudulent characteristic rules of the authenticity rules to extraction data of the predetermined data fields including data fields relating to name associated with the identity of the source of the document, due date, amount due and/or payment or customer reference numbers. Still more preferably the step of authenticity the document comprises applying pattern rules of the predetermined authenticity rules to extraction data of the predetermined data files including data fields relating to frequency of presentment of the document.

### BRIEF DESCRIPTION OF THE DRAWINGS

In order to achieve a better understanding of the nature of the present invention a preferred embodiment of a method of electronically processing a document via an electronic document processing system will now be described, by way of example only, with reference to the accompanying illustrations in which:

FIG. 1 is an exemplary screenshot from a responsive website accessed via the Internet and a web browser on a mobile device, the screenshot depicting “Sign in” to an electronic document processing system enabling one embodiment of the invention for electronically processing a document, when the document is a bill;

FIG. 2 is an exemplary screenshot taken from the responsive website for which “Sign in” has been effected in FIG. 1 showing various functionality which can be enabled in the website including implementation of the method of electronically processing a document, when the document is a bill;

FIG. 3 is an exemplary screenshot of the responsive website of the preceding figures showing sample documents authenticated by the method of the preferred embodiment, when the documents are bills;

FIG. 4 is an exemplary screenshot of one of the sample document taken from the responsive website of FIG. 3 showing the document in its native format, when the document is a bill;

FIGS. 5A and 5B are a logic flow diagram showing exemplary steps involved in validating an email source from which a document is received for approval via an electronic document processing system according to a preferred embodiment of the invention, when the document is a bill;

FIG. 6 is a schematic illustrating the steps involved in processing a document and converting it to a structured format by applying one of a plurality of extraction engines according to an embodiment of the invention;

FIG. 7 is a schematic illustrating select of the extraction engines applied in the methodology of the embodiment of FIG. 6 depending on the native format of the document, when the document is a bill;

FIG. 8 is a schematic illustrating the steps involved in processing a document via an electronic document processing system according to an embodiment of the invention, when the document is a bill;

FIGS. 9A to 9C schematically illustrate exemplary scenarios in the course of processing fraudulent or fake documents implementing the steps illustrated in FIG. 8, when the documents are bills;

FIG. 10 is a schematic illustrating variations on the method of processing a document via an electronic document processing system together with automated payment of the authenticated document, when the document is a bill.

### DETAILED DESCRIPTION

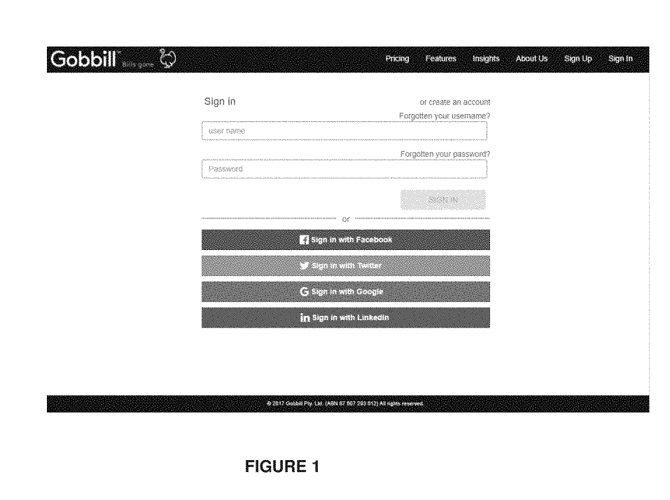

The present invention in one aspect is broadly directed to a method of electronically processing a document via an electronic document processing system. In one implementation the document processing system is deployed to users via a responsive website accessed via the Internet and a web browser on the user's computer or more typically mobile device. FIGS. 1 to 4 depict exemplary screenshots of the responsive website operating in the context of the methodology and document processing system of this embodiment of the invention.

The general steps involved in the method of electronically processing a document of this embodiment are exemplified with reference to a document in the form of a bill, and comprises the following steps:
1. each of the users of the document processing system are allocated a recipient email address, such as “ . . . @gobbill.com”;
2. the recipient email address for each of the users is associated with a user email address nominated by that user, such as “ . . . @gmail.com”;
3. a bill is received from an email source having an email source address, such as “ . . . @gmail.com” or “ . . . @mybill.provider.com.au”;
4. the email source from which the bill is received is validated at the recipient email server;
5. provided the email source is successfully validated, payment approval of the bill is prompted via the electronic document processing system.

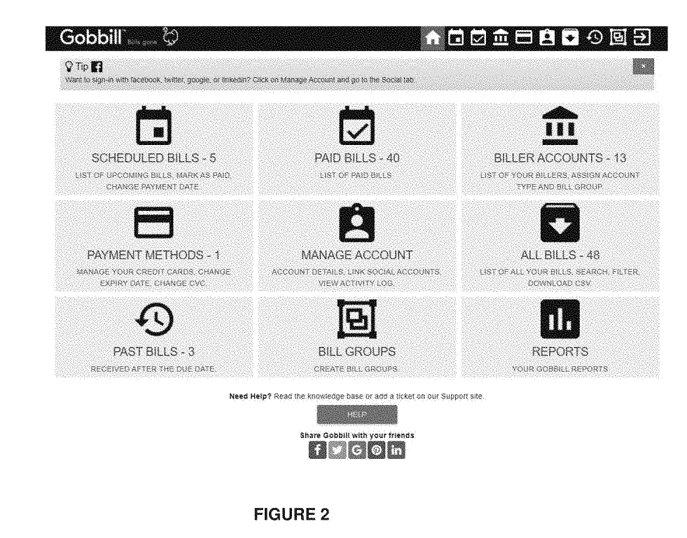

FIG. 1 is an exemplary screenshot of the “Sign in” screen of the responsive website which for users without an allocated recipient email address allows them to “create an account”. FIG. 2 is an exemplary screenshot of the homepage of the website offering the various functionality associated with screen icons and associated shortcuts. In this embodiment the “SCHEDULED BILLS” have been successfully validated and prompted for payment approval via the electronic document processing system.

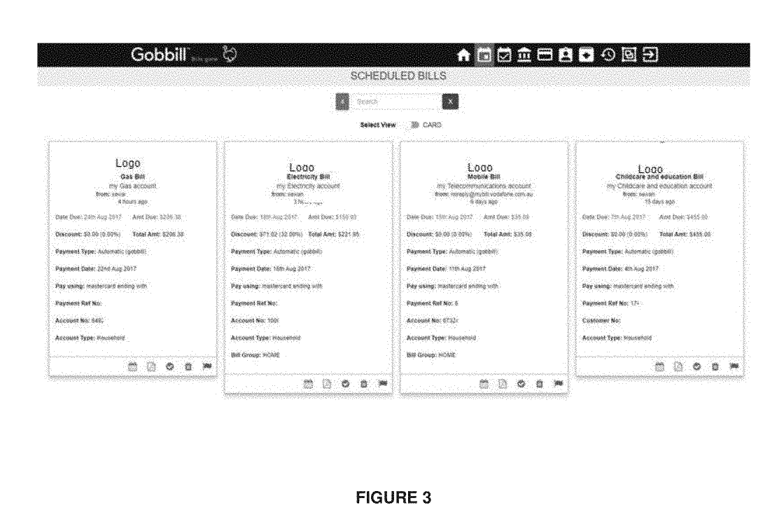

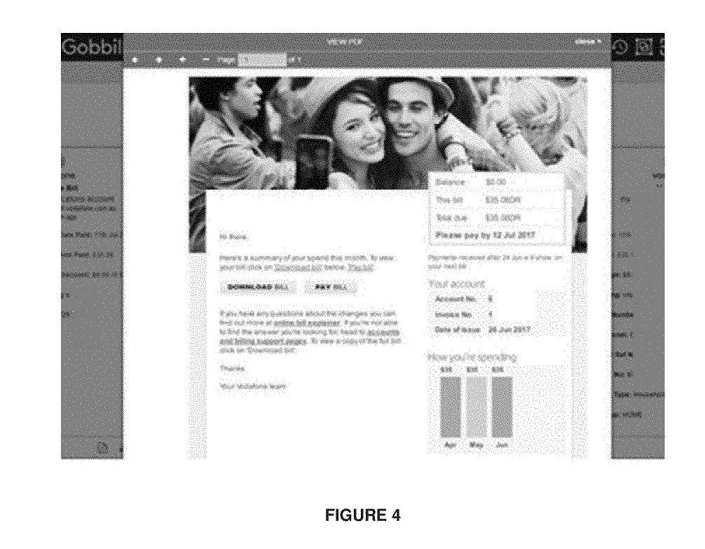

The exemplary screenshot of FIG. 3 depicts sample bills of the “SCHEDULED BILLS” from FIG. 2. These sample bills have been constructed from structured format files converted from a bill in its native format, this conversion being effected by a method of an embodiment of another aspect of the invention. FIG. 4 is an exemplary screenshot of one of the sample bill outputs in its native format. In this example, the native format of the bill is viewed in PDF file format via the shortcut icon shown in FIG. 3.

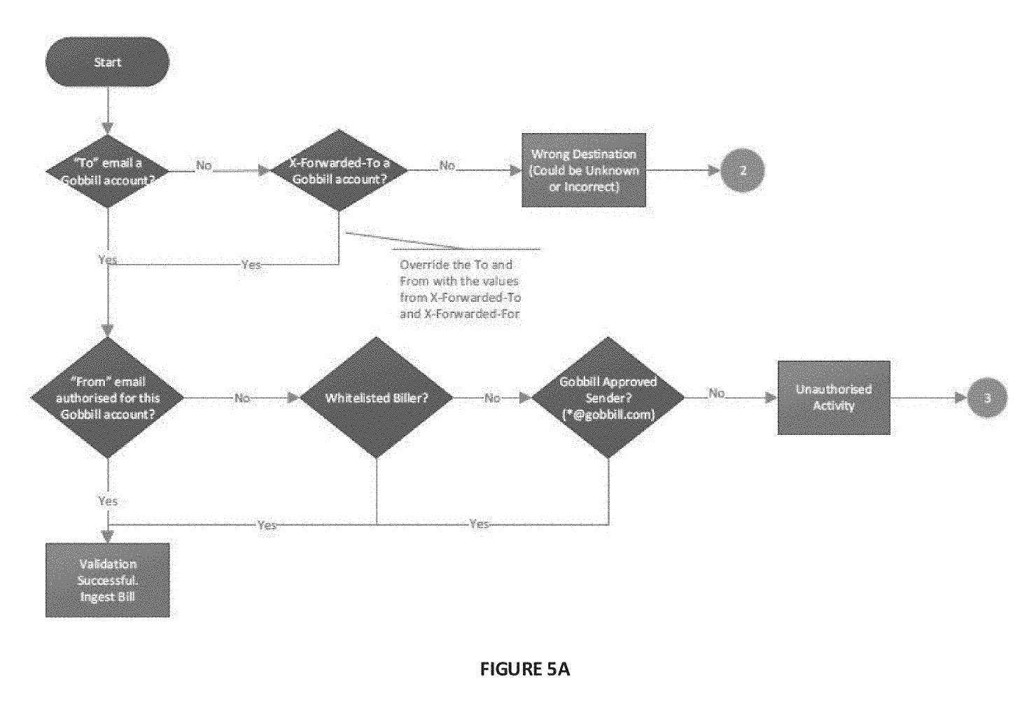

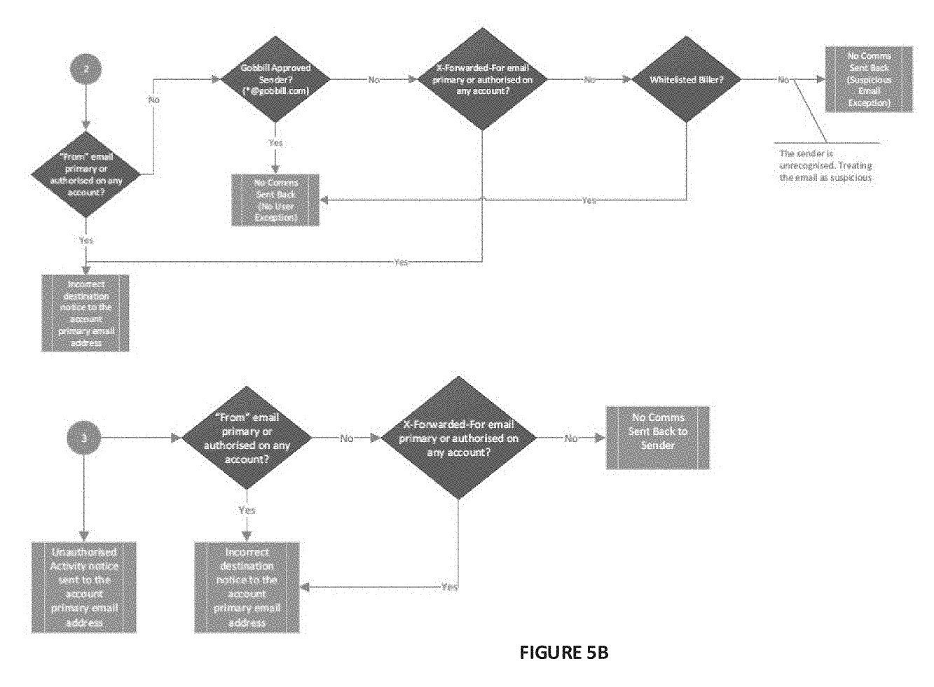

FIGS. 5A and 5B are a logic flow diagram illustrating the steps involved in validating an email source according to a method of another embodiment of a further aspect of the invention. In this example the bill is received at a designated email address, such as “ . . . @gobbill.com” at a recipient email server “Gobbill account”. The recipient email server is associated with the plurality of recipient email addresses such as “joe@gobbill.com” allocated to the plurality of users having their respective nominated user email addresses such as “ . . . @gmail.com” in the earlier aspect of the invention. The recipient email address may be associated with more than one user email address including an authorised email address, for example the email address of a partner or spouse of the nominated user email address. In this embodiment validation of the email source from which the bill is received at the recipient email server involves the steps of:
1. verifying the designated email address “joe@gobbill.com” by matching it with one of the plurality of allocated recipient email addresses “ . . . @gobbill.com”;
2. reconciling the email source address “ . . . @gmail.com” with either (a) the user email address “ . . . @gmail.com” associated with the matched recipient email address “joe@gobbill.com”, or (b) one of the email servers “white listed biller” associated with the matched recipient email address “joe@gobbill.com”.

The email source is successfully validated provided the recipient email address is verified by matching with one of the allocated recipient email addresses “Gobbill account”, and the email source address “ . . . @gmail.com” or “ . . . @mybill.provider.com.au” reconciles. In the event that the designated email address is not verified, routing information in an email header associated with the bill is analysed “X-forwarded to a Gobbill account”. The designated email address will verify if the routing information is consistent with stored historical routing information associated with the matched recipient email address such as “joe@gobbil.com”. In the event the email source address such as “ . . . @gmail.com” does not reconcile, email text associated with the bill is scanned to identify a biller, which is an identity associated with a source of the bill, and confirm the biller is one of said one or more billers associated with the system “white listed biller”. The email servers associated with the billers include third party providers, mail houses, and banks or other financial institutions. This scanning of email text may involve the application of a biller extraction engine configured to extract the name of the biller based on predetermined keywords and/or string patterns.

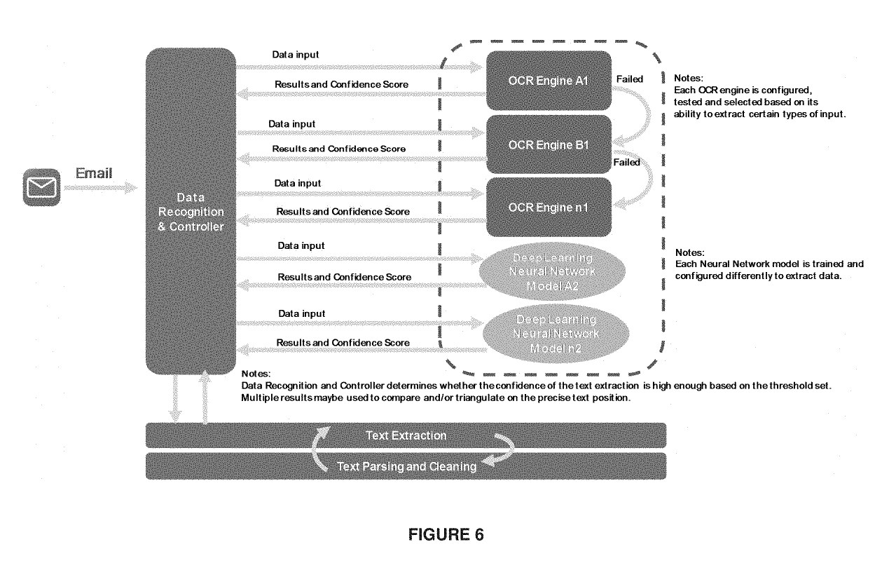

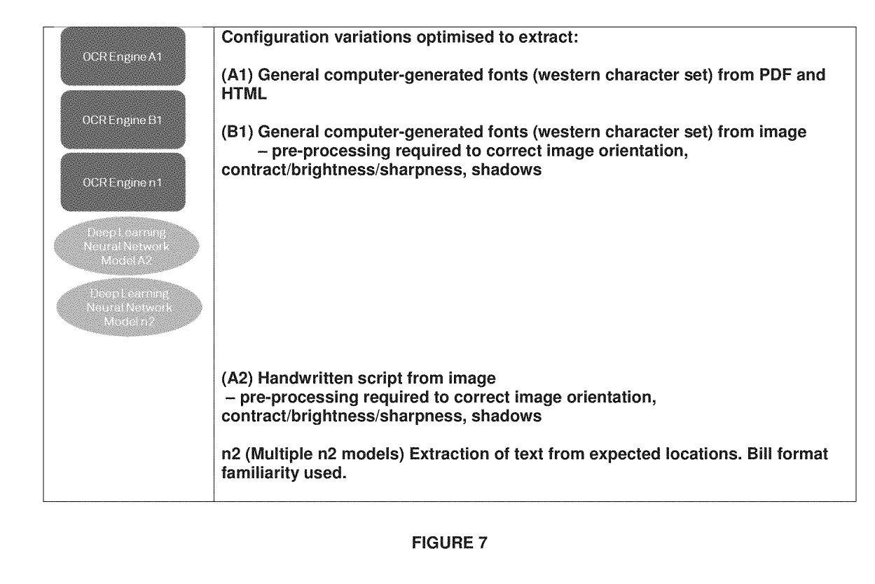

FIGS. 6 and 7 schematically illustrate one embodiment of a method of electronically processing the bill, for example once the email source from which the bill is received is validated. The general steps involved in processing the bill include:
1. receiving the bill in a native format, such as the PDF file illustrated in the screenshot of the website of FIG. 4;
2. providing a plurality of extraction engines such as the Optical Character Recognition (OCR) engines and predictive engines of FIG. 6 each configured to extract data of a characteristic suited to that extraction engine;
3. selecting one or more of the plurality of extraction engines to be applied to the bill depending on the native format of the bill such as the OCR engine A1 alone or in combination with the other extraction engines of FIG. 7;
4. converting the bill from its native format to an output file in a structured format, for example the text files from which the output bills of the exemplary screenshot of the website shown in FIG. 3 are constructed.

In this embodiment, conversion of the bill to the structured format is effected by applying the selected extraction engines to the native bill. The output file in its structured or text format is thus constructed from the extracted data of the suited characteristic of the extraction engine. For example, the predictive extraction engine or “deep learning neural network model A2” is suited to handwritten script from an image, see for example FIG. 7.

In this embodiment, the extraction engines are supplied sequentially to the bill where for example data extracted via one or more OCR engines is combined with data extracted via one or more predictive extraction engines including deep learning algorithms configured for targeted extraction of data from bills. The extraction engines are “chained” wherein extracted data from each engine is compared with data from the preceding engine and, depending on differences in results, the extracted data is combined to obtain the output structured format file at a relative high accuracy.

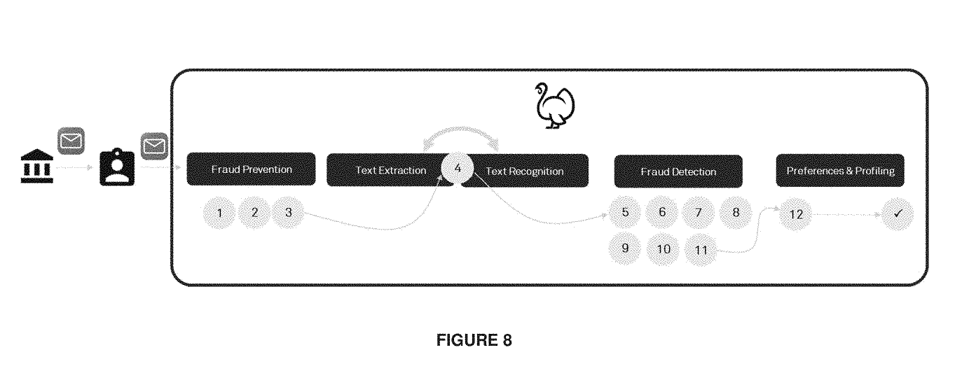

In this embodiment and as illustrated in FIG. 8, the method of electronically processing the bill involves authenticating the bill in its structured or text format “Fraud Detection”. As described in the preceding paragraphs, the preferred method requires validation of the email source “Fraud Prevention” and processing of the bill by converting it to the structured format file “Text Extraction Text Recognition”. In this example the preliminary steps involved in validating the email source or “Fraud Prevention” according to the numbered sequence of FIG. 8 is:
1. verify the designated email address such as “ . . . @gobbill.com” exists in the system;
2. review routing information in the email header such as “X-forwarded-to, X-forwarded-from” headers and validate against the recipient email address or “Gobbill account”;
3. reconcile the email source address with either the user email address or the “white listed” biller address.

In FIG. 8, item 4 identifies processing of the native bill by converting it to a structured format file and extraction of data from predetermined data fields in the structured or text file. If the biller is recognised and known to the system, the bill then progresses to more substantive authentication in the course of “Fraud Detection”. In this example, this authentication involves applying predetermined authenticity rules to the extracted data including:
1. payment rules where extracted data relating to payment of the bill is compared with payment data of verified or fraudulent sources;
2. pattern rules where extracted data of predetermined data fields including data fields relating to the frequency of presentment of the bill identifies irregularities;
3. fraudulent characteristic rules where extracted data of predetermined data fields relating to biller name, due date, amount due and/or payment or customer reference numbers are examined

In the context of FIG. 8 and adopting the same number sequences authentication of the bill involves:
5. extracting data fields (issue date, due date) and validating they conform to an acceptable format in the system database;
6. extracting at least one of the applicable account number/customer number/payment reference number and validating it conforms to an acceptable format in the system database;
7. extracting bill amounts (amount due, GST, discount amount) and validating to ensure they are numbers and conform to expectations from the system database;
8. if a payment link is available, checking the system to ensure it is a “white listed” payment link on the system.

In this embodiment, the data or metadata extracted in steps 5 to 7 is audited to ensure sufficient information has been extracted to ingest the bill in the system, see item 9. The data or metadata is compared to existing bills in the system to ensure it is not a duplicate bill, see item 10. If the bill has tokens in links such as payment links, the token cache is checked to ascertain whether the bill is a new fake replication, is duplicated or is a “black listed” fake bill, see item 11.

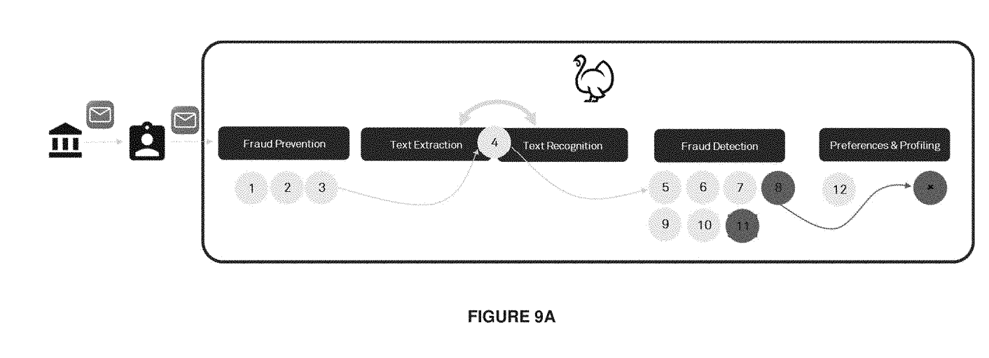

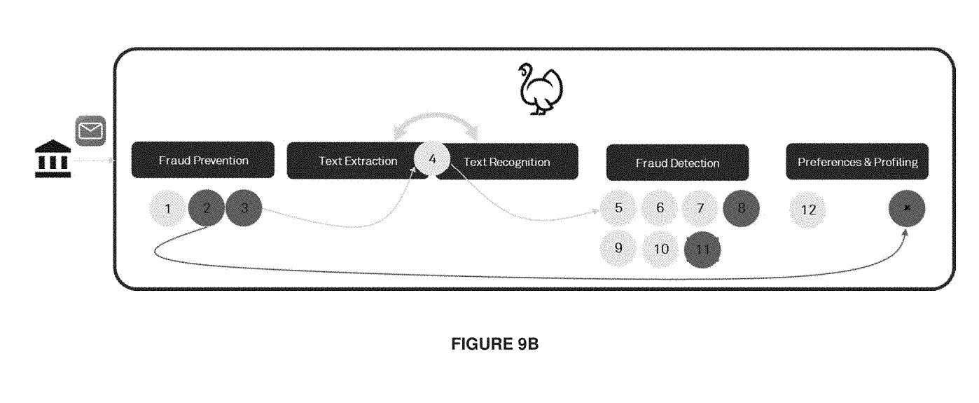

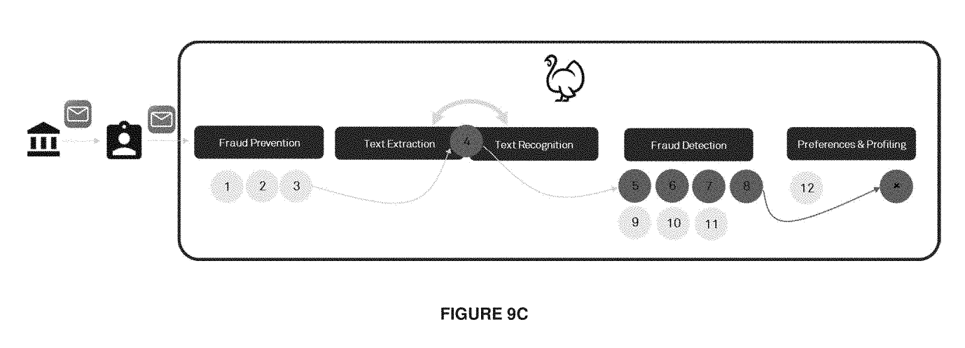

FIGS. 9A to 9C illustrate different scenarios for detection of fake bills by applying the methodology of the preceding embodiment. In this example the email source is validated and subsequently the bill is authenticated by applying predetermined authenticity rules to data extracted from a structured format file. The structured format file is derived from the bill in its native format by applying selected extraction engines to the native bill as described in the earlier embodiment.

In the exemplary scenario of FIG. 9A, a fake bill using a copy of original bill in a HTML format is sent to a user. The unsuspecting user forwards the bill to their system account such as “ . . . @gobbill.com”. In this case the highlighted processing steps of 8 and 11 detect the suspicious nature of the fake bill. In particular, at step 8 it is revealed that the payment link is unknown and at step 11 the normal bill tokens associated with the link are missing.

In a second scenario illustrated in FIG. 9B, a fake bill using a copy of an original HTML bill is sent directly to the system or account, for example allegedly from a biller associated with the account such as “ . . . @mybill.provider.com.au”. In this instance the highlighted processing steps of 2, 3, 8 and 11 detect the suspicious nature of the email bill. In particular, the system at:
1. step 2 on analysing routing information in the email header reveals that the domain and internet route is from overseas;
2. step 3 the source email address does not reconcile with the email servers associated with the system and as such is not a “white listed biller”;
3. steps 8 and 11 the payment link is unknown to the system and the necessary bill tokens are missing from the link.

In scenario 3 shown in FIG. 9C, a fake bill in a PDF format with malware within the bill is sent to the user. The unsuspecting user forwards it to the system at their account “ . . . @gobbill.com”. In this instance the highlighted processing steps 4 to 8 detect the suspicious email bill. For example, in step 8 the system reveals the payment link is associated with malware code/script and is not “white listed”.

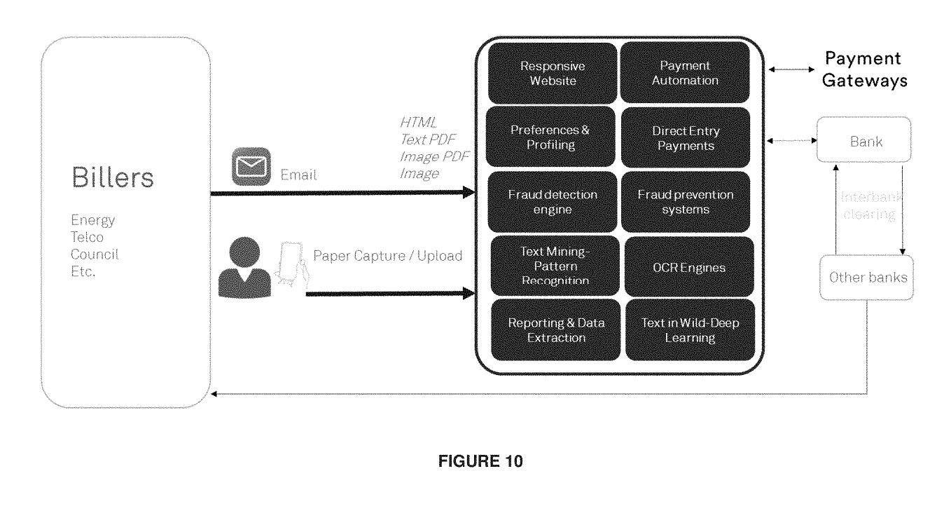

FIG. 10 schematically illustrates the electronic document processing system of the preceding embodiment. The bill is either emailed directly to the system from the user, or with the authority of the user emailed from the biller. In an alternative embodiment the bill is uploaded to the system, for example by capturing a photograph of the bill and uploading it to the system via the responsive website of the earlier embodiment. The system of this embodiment includes the illustrated modules for validating the email source and converting the bill in its native format to a structured file format. The system also includes modules for authenticating data extracted from predetermined fields in the structured format file by application of predetermined authenticity rules, such as the “Fraud Detection Engine” and “Fraud Prevention Systems”. In the event the bill is successfully authenticated the electronic document processing system prompts for payment of the bill via secure payment gateways generally using the stored payment instrument associated with the user. Alternatively, the bill may be automatically paid by the biller on standing instructions from the user or customer.

Now that a preferred embodiment of a method of electronically processing a document via an electronic document processing system has been described it will apparent to those skilled in the art that it has the following advantages:
1. the system is effective in identifying invalid sources from which fake documents such as fake bills are received;
2. the system provides accurate conversion of documents such as bills in their native format to a structured format relying on one or more extractions engines each configured to extract data of a characteristic suited to that extraction engine;
3. the accurate extraction of data and subsequent application of authenticity rules to the extracted data provides a high confidence level of genuine documents, typically with no suspicious features detected;
4. the processing of documents, such as payment of bills, is effected on successful ingestion of genuine bills into the system.

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Those skilled in the art will appreciate that the invention described herein is susceptible to variations and modifications other than those specifically described. For example, the selection of extraction engines may vary from the preferred embodiment depending on the native format of the bill. The method may depart from the preferred embodiment in the event the bill is uploaded to the system, in which case, validation of the email source is no longer relevant. All such variations and modifications are to be considered within the scope of the present invention the nature of which is to be determined from the foregoing description.

1. A method of electronically processing a document via an electronic document processing system, said method comprising the steps of:
allocating a plurality of recipient email addresses to respective of a plurality of users of the document processing system;
for each of the plurality of users, associating the recipient email address with a user email address nominated by the user;
for each of the plurality of users, associating one or more identities associated with a source of a document with the recipient email address, each of said one or more identities being associated with respective one or more email servers;
receiving a document from an email source having an email source address, said document being received at a designated email address at a recipient email server associated with the plurality of recipient email addresses;
validating the email source from which the document is received at the recipient email server, said validation comprising the steps of i) verifying the designated email address by matching it with one of the plurality of allocated recipient email addresses, and ii) reconciling the email source address with either the user email address associated with the matched recipient email address, or one of the email servers associated with the matched recipient email address;
provided the email source is successfully validated processing the document by converting it to a structured format file;
extracting data from predetermined data fields in the structured format file;
authenticating the document by applying predetermined authenticity rules to the extracted data.

2. A method as claimed in claim 1 comprising the step of, prior to processing the document by converting it to a structured format file, scanning email text associated with the document to identify an identity associated with a source of the document and confirming the identity is one of said one or more identities associated with the system.

3. A method as claimed in claim 2 wherein the step of scanning the email text comprises applying an identity extraction engine configured to extract the identity based on predetermined keywords and/or character string patterns.

4. A method as claimed in claim 1 wherein the step of converting the document to
a structured format file comprises the steps of:
providing a plurality of extraction engines each configured to extract data of a characteristic suited to that extraction engine;
selecting one or more of the plurality of extraction engines to be applied to the document depending on the native format of the document;
applying the selected extraction engines to the native document wherein the output file is constructed from the extracted data of the suited characteristic of the respective extraction engine.

5. A method of validating an email source via an electronic document processing
system, said method comprising the steps of:
allocating a plurality of recipient email addresses to respective of a plurality of users of the document processing system;
for each of the plurality of users, associating the recipient email address with a user email address nominated by the user;
for each of the plurality of users, associating one or more identities associated with a source of a document with the recipient email address, each of said one or more identities being associated with respective of one or more email servers;
receiving a document from an email source having an email source address, said document being received at a designated email address at a recipient email server associated with the plurality of recipient email addresses;
validating the email source from which the document is received at the recipient email server, said validation comprising the steps of i) verifying the designated email address by matching it with one of the plurality of allocated recipient email addresses, and ii) reconciling the email source address with either the user email address associated with the matched recipient email address, or one of the email servers associated with the matched recipient email address.

6. A method as claimed in claim 5 wherein the step of validating the email source from which the document is received at the recipient email server comprises the step of analysing routing information in an email header associated with the document and confirming the routing information is consistent with stored historical routing information associated with the matched recipient email address.

7. A method as claimed in claim 5 comprising the step of processing the document by i) converting the document from its native format to an output file in a structured format, ii) extracting data from predetermined data fields in the structured format file, and iii) authenticating the document by applying a set of predetermined authenticity rules to the extracted data.

8. A method as claimed in claim 7 wherein the step of converting the document to
a structured format file comprises the steps of:
providing a plurality of extraction engines each configured to extract data of a characteristic suited to that extraction engine;
selecting one or more of the plurality of extraction engines to be applied to the document depending on the native format of the document;
applying the selected extraction engines to the native document wherein the output file is constructed from the extracted data of the suited characteristic of the respective extraction engine.

9. A method of electronically processing a document, said method comprising the steps of:
receiving the document in a native format;
providing a plurality of extraction engines each configured to extract data of a characteristic suited to that extraction engine;
selecting one or more of the plurality of extraction engines to be applied to the document depending on the native format of the document;
converting the document from its native format to an output file in a structured format by applying the selected extraction engines to the native document wherein the output file is constructed from the extracted data of the suited characteristic of the respective extraction engine;
providing the output file in the structured format.

10. A method as claimed in claim 9 comprising the step of authenticating the document by applying predetermined authenticity rules to the extracted data.

11. A method as claimed in claim 8 wherein the application of the selected extraction engines comprises sequentially applying multiple optical character recognition engines to the document.

12. A method as claimed in claim 11 wherein the application of the selected extraction engines comprises applying one or predictive extraction engines including deep learning algorithms configured for targeted extraction of data from the document, said data extracted via the predictive extraction engines combining with extracted data from other of the selected extraction engines.

13. A method as claimed in claim 12 wherein the step of sequentially applying the selected extraction engines comprises comparing extracted data from the preceding engine and, depending on differences in results, combining the extracted data from each of the selected extraction engines to obtain the output structured format file at a relatively high accuracy.

14. A method as claimed in claim 1 wherein the step of authenticating the document comprises comparing extracted data relating to processing of the document with data of verified or fraudulent sources, and applying rules of the predetermined authenticity rules to the compared extracted payment data to approve the document.

15. A method as claimed in claim 1 wherein the step of authenticating the document comprises applying fraudulent characteristic rules of the authenticity rules to extraction data of the predetermined data fields including data fields relating to name associated with the identity of the source of the document, due date, amount due and/or payment or customer reference numbers.

16. A method as claimed in claim 1 wherein the step of authenticating the document comprises applying pattern rules of the predetermined authenticity rules to extraction data of the predetermined data files including data fields relating to frequency of presentment of the document.

17. A method as claimed in claim 7 wherein the step of authenticating the document comprises applying fraudulent characteristic rules of the authenticity rules to extraction data of the predetermined data fields including data fields relating to name associated with the identity of the source of the document, due date, amount due and/or payment or customer reference numbers.

18. A method as claimed in claim 7 wherein the step of authenticating the document comprises applying pattern rules of the predetermined authenticity rules to extraction data of the predetermined data files including data fields relating to frequency of presentment of the document.

19. A method as claimed in claim 10 wherein the step of authenticating the document comprises applying fraudulent characteristic rules of the authenticity rules to extraction data of the predetermined data fields including data fields relating to name associated with the identity of the source of the document, due date, amount due and/or payment or customer reference numbers.

20. A method as claimed in claim 10 wherein the step of authenticating the document comprises applying pattern rules of the predetermined authenticity rules to extraction data of the predetermined data files including data fields relating to frequency of presentment of the document.
